(19) United States
(12) Patent Application Publication
(10) Pub. No.: US 2023/0159115 A1
(43) Pub. Date: May 25, 2023

(54) RETRACTABLE UNDER CHASSIS FAIRING

(71) Applicant: Volvo Truck Corporation, GöteBorg (SE)

(72) Inventor: Carl Bjoerk, Greensboro, NC (US)

(21) Appl. No.: 17/919,343

(22) PCT Filed: Jun. 15, 2020
(86) PCT No.: PCT/US2020/037703

§ 371 Date: Oct. 17, 2022

(51) Int. Cl. B62D 35/02; B62D 35/00

(52) U.S. Cl. CPC B62D 35/02; B62D 35/001

(57) ABSTRACT

Aspects of the disclosure relate to a retractable under chassis fairing. In certain embodiments, the under chassis fairing includes a fairing body and at least one coupling. The fairing body includes a floor, front wall, and left and right sidewalls. The front wall extends from a front edge of the fairing body to the floor toward a back edge of the fairing body and is angled relative to the floor. The at coupling is configured to hang the fairing body from a chassis such that an upper edge of the left and right sidewalls is positioned at the same height as or higher than a lower edge of the vehicle. The coupling is configured to allow movement of the fairing body from a lowered position vertically toward the chassis upon contact with a road obstacle. The under chassis fairing improves aerodynamic performance while moving upon contact with road obstacles.

### FIELD OF THE DISCLOSURE

The disclosure relates generally to under chassis fairings. In particular aspects, the disclosure relates to vehicles and retractable under chassis fairings.

### BACKGROUND

Aerodynamic drag of a vehicle affects fuel economy. Accordingly, improving aerodynamic design results in better fuel efficiency, especially for vehicles (e.g., heavy truck vehicles) that travel long distances at high speeds.

One source of aerodynamic drag is the ground clearance of the vehicle. Vehicles require ground clearance to navigate road obstacles and prevent damage to an underside of the vehicle. However, increasing ground clearance increases aerodynamic drag, and therefore reducing ground clearance reduces aerodynamic drag.

### SUMMARY

According to an aspect of the disclosure, an under chassis fairing includes a fairing body and at least one coupling. The fairing body includes a floor, a front wall, a left sidewall, and a right sidewall. The front wall extends from a front edge of the fairing body to the floor toward a back edge of the fairing body and is angled relative to the floor. The at least one coupling is configured to hang the fairing body from a chassis of a vehicle such that an upper edge of the left sidewall and the right sidewall is positioned at the same height as or higher than a lower side edge of the outer surface of a vehicle body of the vehicle . The at least one coupling is configured to allow movement of the fairing body from a lowered position vertically toward the chassis upon contact with a road obstacle.

In certain embodiments, the left sidewall and the right sidewall are planar and extend from the front wall to a back edge of the floor.

In certain embodiments, each of the left sidewall and the right sidewall comprises a laterally extended portion.

In certain embodiments, the fairing body defines a gap between a left rearward edge of the left sidewall and a right rearward edge of the right sidewall.

In certain embodiments, the fairing body includes a metal material.

In certain embodiments, the at least one coupling includes a front coupling configured to hang from a front axle of the chassis of the vehicle.

In certain embodiments, the at least one coupling includes a back coupling configured to hang from a rear axle of the chassis of the vehicle.

In certain embodiments, the at least one coupling includes at least one of a strap, a telescopic strut, a hook, or a bracket.

In certain embodiments, the at least one coupling includes a metal bracket.

In certain embodiments, the under chassis fairing further includes at least one guide configured to allow vertical movement and restrict lateral movement of the under chassis fairing relative to the chassis.

In certain embodiments, the at least one guide includes at least one vertical slot configured to receive at least a portion of an axle of the chassis therein.

In certain embodiments, the at least one coupling comprises the at least one guide.

In certain embodiments, the at least one guide includes a front guide configured to engage at least a portion of a front axle and a back guide configured to engage at least a portion of a rear axle.

According to another aspect of the disclosure, a vehicle includes a vehicle body, a chassis, and an under chassis fairing. The vehicle body has an outer surface. The chassis includes a front axle and a rear axle. The under chassis fairing hangs from the chassis. The under chassis fairing includes a fairing body and at least one coupling. The fairing body includes a floor, a front wall, a left sidewall, and a right sidewall. The front wall extends from a front edge of the fairing body to the floor toward a back edge of the fairing body and is angled relative to the floor. The at least one coupling is configured to hang the fairing body from a chassis of a vehicle such that an upper edge of the left sidewall and the right sidewall is positioned at the same height as or higher than a lower side edge of the outer surface of a vehicle body of the vehicle. The at least one coupling is configured to allow movement of the fairing body from a lowered position vertically toward the chassis upon contact with a road obstacle.

In certain embodiments, the under chassis fairing includes a front coupling configured to hang from the front axle of the chassis of the vehicle.

In certain embodiments, the under chassis fairing further includes a front guide configured to allow vertical movement and restrict lateral movement of the under chassis fairing relative to the chassis.

In certain embodiments, the front axle includes at least one nub inserted into at least a portion of the front guide to restrict lateral movement of the under chassis fairing relative to the chassis.

In certain embodiments, the under chassis fairing includes a back coupling configured to hang from the rear axle of the chassis of the vehicle.

In certain embodiments, the under chassis fairing further includes a back guide configured to allow vertical movement and restrict lateral movement of the under chassis fairing relative to the chassis.

In certain embodiments, the rear axle includes at least one nub inserted into at least a portion of the back guide to restrict lateral movement of the under chassis fairing relative to the chassis.

Additional features and advantages will be set forth in the detailed description which follows, and in part will be readily apparent from that description to those skilled in the art or recognized by practicing the embodiments as described herein, including the detailed description which follows, the claims, as well as the appended drawings.

It is to be understood that both the foregoing general description and the following detailed description are merely exemplary, and are intended to provide an overview or framework for understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1A is a side view of a vehicle including a retractable under chassis fairing.

FIG. 1B is a top view of the vehicle and under chassis fairing of FIG. 1A.

FIG. 1C is a perspective view of an under chassis fairing with planar sidewalls mounted to axles of the vehicle of FIGS. 1A-1C.

FIG. 2A is a top view of the vehicle and an under chassis fairing with non-planar sidewalls mounted to axles of the vehicle of FIGS. 1A-1C.

FIG. 2B is a perspective view of the under chassis fairing of FIG. 2A.

FIG. 3A is a perspective view of the under chassis fairing of FIGS. 2A-2B mounted to a chassis by mechanical joints.

FIG. 3B is a perspective view of the mechanical joint of FIG. 3A.

FIG. 4A is a side view of the under chassis fairing of FIGS. 1A-1C in an extended position as the under chassis fairing approaches a road obstacle.

FIG. 4B is a side view of the under chassis fairing of FIG. 4A with a front of the under chassis fairing in a retracted position and a rear of the under chassis fairing in the extended position as the under chassis fairing travels over the road obstacle.

FIG. 4C is a side view of the under chassis fairing of FIG. 4A with the front of the under chassis fairing in the retracted position and the rear of the under chassis fairing in the retracted position as the under chassis fairing travels over the road obstacle.

FIG. 4D is a side view of the under chassis fairing of FIG. 4A with the front of the under chassis fairing in the extended position and the rear of the under chassis fairing in the retracted position as the under chassis fairing travels over the road obstacle.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

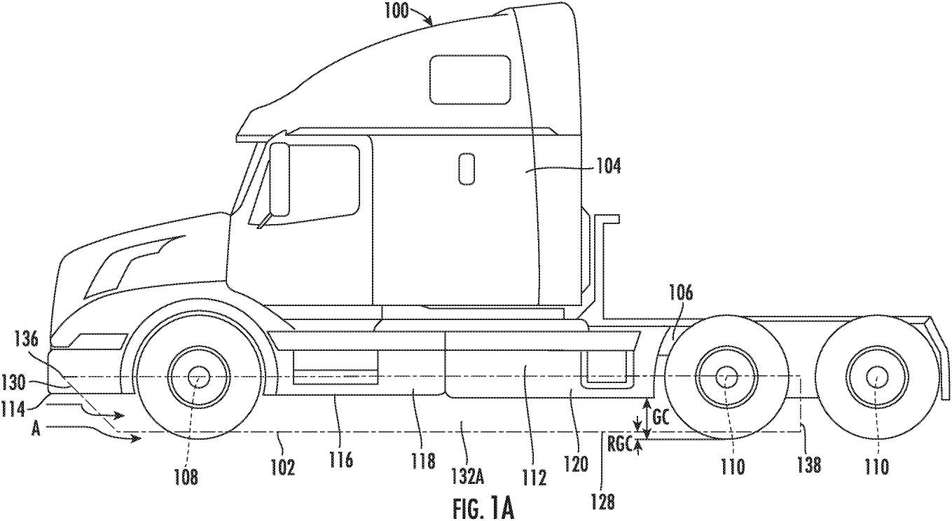

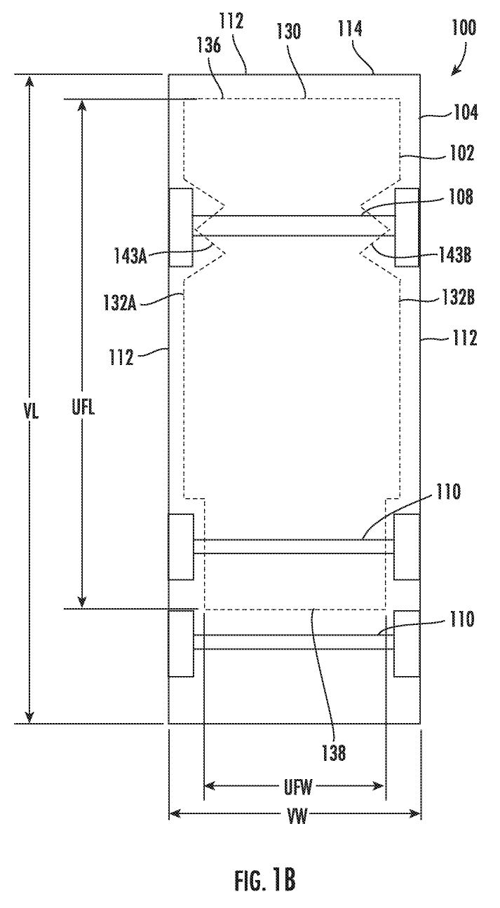

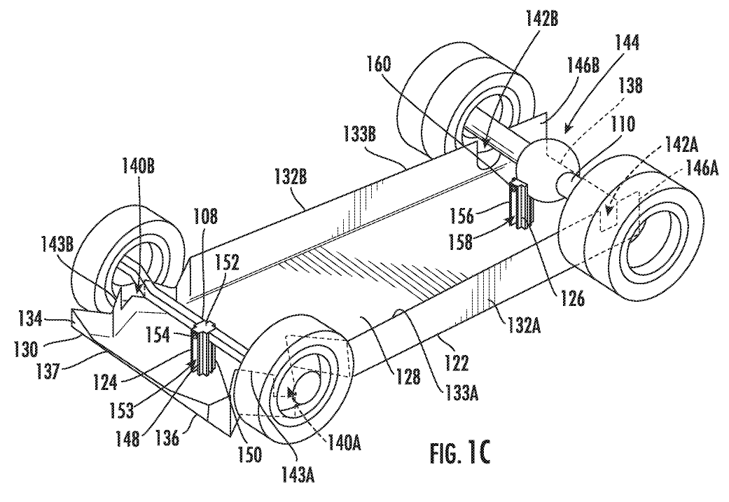

FIGS. 1A-1C are views of a vehicle 100 including a retractable under chassis fairing 102. The vehicle 100 further includes a vehicle body 104 (may also be referred to as a cab body) and a chassis 106 (may also be referred to as a vehicle frame) including a front axle 108 and two rear axles 110. Although the vehicle 100 shown is a truck, it is noted that the retractable under chassis fairing 102 may be used on other types of vehicles. Further, it is noted that the under chassis fairing 102 may also be positioned underneath a trailer or any other part of the vehicle.

The vehicle body 104 has an outer surface 112 including a lower front edge 114 and a lower side edge 116. Ground clearance GC is measured from the ground to the lower front edge 114 and/or the lower side edge 116. The vehicle body 104 includes a chassis fairing 118 partially defining the outer surface 112 and the lower side edge 116. The vehicle body 104 further includes a full side fairing 120 partially defining the outer surface 112 and the lower side edge 116. As shown, the under chassis fairing 102 extends downwardly past the lower front edge 114 and the lower side edge 116.

In certain embodiments, the under chassis fairing 102 (may also be referred to as a tub, an aerodynamic tub, etc.) includes a fairing body 122 and at least one coupling including a front coupling 124 and a back coupling 126 attaching the fairing body 122 to the vehicle body 104. As described in more detail below, the front and back couplings 124, 126 are configured to hold the body in an extended lower position and allow upward vertical movement of the body when encountering an obstacle. The fairing body 122 includes a floor 128, a front wall 130, a left sidewall 132A, and a right sidewall 132B. In certain embodiments, the fairing body 122 includes a metal material and/or any other rigid material that independently retains size and shape.

The floor 128 is substantially horizontal when installed on a vehicle, that is, the floor is substantially parallel to the chassis 106. The front wall 130 includes a planar portion 134 and an angled portion 136 may also be referred to as a ramp) positioned beneath the planar portion 134. The planar portion 134 is substantially perpendicular to the floor 128. In certain embodiments, the front wall 130 only includes an angled portion 136 (without a planar portion 134). The angled portion 136 extends between a front edge 137 of the fairing body 122 rearward to the floor 128. The angled portion 136 is angled (i.e., at a non-zero angle) relative to the planar portion 134 and/or the floor 128. The angled portion 136 provides an impact surface that facilitates upward movement of the under chassis fairing 102 upon contacting (i.e., striking) a road obstacle. Further, the angled portion 136 directs airflow A (see FIG. 1) around and/or underneath the under chassis fairing 102. In certain embodiments, the front wall 130 is also angled from a center toward the sidewalls 132A, 132B, such as to facilitate airflow outward (e.g., to further reduce aerodynamic drag).

In certain embodiments, the left sidewall 132A includes a front left cut-out 140A and a rear left cut-out 142A. When the under chassis fairing 102 moves upward, the front left cut-out 140A at least partially receives the front axle 108, and the rear left cut-out 142A at least partially receives the rear axle 110. A similar configuration is provided in the right sidewall 132B. Front right cut-out 140B and rear right cut-out 142B provide clearance for vertical movement of the under chassis fairing 102. In certain embodiments, the left sidewall 132A and the right sidewall 132B are planar and extend from the front wall 130 to the back edge 138 of the floor 128. In certain embodiments, the left sidewall 132A includes steering indentations 143A on opposing sides of the front left cut-out 140A, and the right sidewall 132B includes steering indentations 143B on opposing sides of the front right cut-out 140B to provide clearance to accommodate turning the steered wheels. In certain embodiments, the steering indentations 143A, 143B are generally M shaped. In certain embodiments, the steering indentations 143A, 143B are planar. In other embodiments, the steering indentations 143A, 143B include curved portions. In certain embodiments, the cut-outs 140A, 140B are offset from the sidewalls 132A, 132B within one indentation 143A, 143B (e.g., of a semicircle shape). In certain embodiments, the steering indentations 143A, 143B are also provided for the rear wheels.

In certain embodiments, the front wall 130 and the sidewalls 132A, 132B extend upwardly from the floor 128 to the same height. In certain embodiments, upper edges 133A, 133B of the sidewalls 132A, 132B are parallel to the floor 128. Further, in certain embodiments, the sidewalls 132A, 132B extend rearward to the back edge 138 and maintain a same height from the front edge 137 to the back edge 138. As the upper edges 133A, 133B of the sidewalls 132A, 132B are positioned higher than the lower side edge 116 of the vehicle 100, this overlap ensures that the under chassis fairing 102 extends downwardly from the lower side edge 116 of the vehicle 100 along a length of the vehicle 100 to form a reduced ground clearance RGC (see FIG. 1) which reduces aerodynamic drag of the vehicle 100.

In certain embodiments, the fairing body 122 defines a gap 144 between a left rearward edge 146A of the left sidewall 132A and a right rearward edge 146B of the right sidewall 132B. This gap 144 allows dust, debris, or any other foreign object that may enter the interior of the under chassis fairing 102 to exit through the gap 144, thereby preventing accumulation. Further, as the gap 144 is positioned at the rear, the gap 144 does not increase aerodynamic drag. However, in certain embodiments, the fairing body 122 includes a back wall.

In certain embodiments, the sidewalls 132A, 132B of the under chassis fairing 102 do not extend past the outer surface 112 of the vehicle 100 and are not attached to the outer surface 112 of the vehicle 100. In certain embodiments, the sidewalls 132A, 132B extend up to the outer surface 112 of the vehicle 100.

It is noted that in certain embodiments, the under chassis fairing length UFL of the under chassis fairing 102 (from the front edge 137 to the back edge 138) is configured to cover a vehicle length VL of the vehicle 100 (from a front to a rear of the vehicle). In certain embodiments, the under chassis fairing 102 extends from proximate a front of the vehicle 100 past the front axle 108. In certain embodiments, the under chassis fairing 102 extends from proximate the front of the vehicle 100 past the front axle 108 and at least one of the rear axles 110. In certain embodiments, the under chassis fairing extends from proximate the front of the vehicle 100 past the front axle 108 and all of the rear axles 110. For example, in certain embodiments, the under chassis fairing 102 extends from between 50% to 100% of the length of the vehicle 100, from between 70% to 80% of the length of the vehicle 100, and/or from between 70% to 90% of the length of the vehicle 100. In certain embodiments, the under chassis fairing 102 has a length of 5 feet to 30 feet, 10 feet to 25 feet, 15 feet to 20 feet, 10 feet to 15 feet, etc.

The under chassis fairing width UFW of the under chassis fairing 102 is configured to cover a vehicle width VW of the vehicle 100. For example, in certain embodiments, the under chassis fairing 102 extends from between 50% to 100% of the length of the vehicle 100, from between 70% to 80% of the length of the vehicle 100, and/or from between 70% to 90% of the length of the vehicle 100. In certain embodiments, the under chassis fairing 102 has a width of 60 inches to 120 inches, 70 inches to 100 inches, 80 inches to 95 inches, 85 to 90 inches, etc. In certain embodiments, the under chassis fairing 102 is configured to cover a certain footprint of the vehicle 100. For example, in certain embodiments, the under chassis fairing 102 is configured to cover from between 50% to 100% of the footprint of the vehicle 100, from between 70% to 80% of the footprint of the vehicle 100, and/or from between 70% to 90% of the footprint of the vehicle 100.

The front coupling 124 is configured to hang the fairing body 122 from the front axle 108 of the chassis 106 of the vehicle 100, and the back coupling 126 is configured to hang the fairing body 122 from the rear axle 110 of the chassis 106 of the vehicle 100. In certain embodiments, the at least one coupling includes at least one of a strap, a telescopic strut, a hook, a bracket (e.g., metal bracket), etc. However, the fairing body 122 could be hung from other parts of the vehicle 100.

In certain embodiments, the front coupling 124 is a bracket (e.g., a U-shaped bracket) including a frontward column 148, a rearward column 150, and a crossbeam 152 at a top of and connecting the frontward column 148 and the rearward column 150. The frontward column 148 is positioned forward of the front axle 108, and the rearward column 150 is positioned rearward of the front axle 108 such that the front axle 108 is positioned between the frontward column 148 and the rearward column 150. Such a configuration allows vertical movement of the under chassis fairing 102 relative to the chassis 106 by allowing the front axle 108 to move vertically between and relative to the frontward column 148 and rearward column 150. Further, such configuration restricts forward/rearward lateral movement of the under chassis fairing 102 relative to the chassis 106 by preventing the front axle 108 from moving laterally past the frontward column 148 and the rearward column 150. The crossbeam 152 is positioned above the front axle 108 thereby allowing the under chassis fairing 102 to hang by the crossbeam 152. This also provides a limit to the extended position of the under chassis fairing 102.

In certain embodiments, the front coupling 124 includes at least one guide embodied as a front vertical slot 153 defined in the frontward column 148. The front vertical slot 153 is configured to receive or engage a portion of the front axle 108 and/or a front guiding component 154 (e.g., nub, pin, etc.) fixedly attached to the front axle 108. Such a configuration allows vertical movement of the under chassis fairing 102 relative to the chassis 106 by allowing the front guiding component 154 to move within the front vertical slot 153. Further, such configuration restricts lateral side-to-side movement of the under chassis fairing 102 relative to the chassis 106 by preventing the front guiding component 154 from moving laterally out of the front vertical slot 153 and past the frontward column 148. In certain embodiments, the fairing body 122 does not extend underneath the front axle 108.

The back coupling 126 includes a frontward column 156 and includes at least one guide embodied as a back vertical slot 158 defined in the frontward column 156. The vertical slot 158 is configured to receive or engage a portion of the rear axle 110 and/or a back guiding component 160 (e.g., nub, etc.) fixedly attached to the rear axle 110. The top of the frontward column 156 of the back coupling 126 hangs on the back guiding component 160. Accordingly, the back coupling 126 also allows for vertical movement of the under chassis fairing 102 while restricting lateral movement.

Each of the front vertical slot 153 and the back vertical slot 158 is configured to allow vertical movement and restrict lateral movement of the under chassis fairing 102 relative to the chassis 106. It is noted that features of the front coupling 124 and the back coupling 126 are interchangeable and that other types of couplings may be used.

As a result, upper edges 133A, 133B of the left sidewall 132A and the right sidewall 132B of the fairing body 122 are positioned at the same height as or higher than the lower side edge 116 of the outer surface 112 of the vehicle 100 so that the left sidewall 132A and the right sidewall 132B of the fairing body 122 extend downward from the lower side edge 116 of the outer surface 112 of the vehicle body 104 of the vehicle 100. In an extended position, the under chassis fairing 102 reduces the ground clearance of the vehicle 100 to increase the aerodynamic profile of the vehicle 100 and reduce aerodynamic drag. Further, the floor 128 and/or sidewalls 132A, 132B of the under chassis fairing 102 extend along a length of the vehicle to improve laminar flow past the vehicle 100 and reduce aerodynamic drag. The front and back couplings 124, 126 are configured to allow movement of the fairing body 122 from a lowered position vertically toward (and relative to) the chassis 106 upon contact with a road obstacle. In other words, the fairing body 122 is able to move upward toward the vehicle body 104.

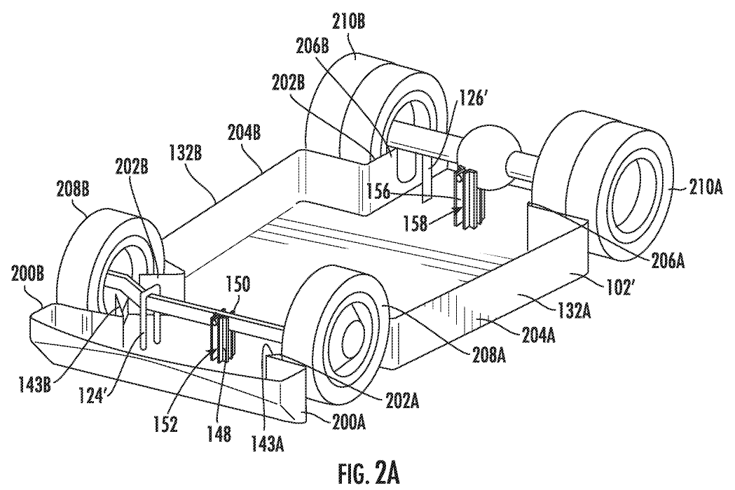

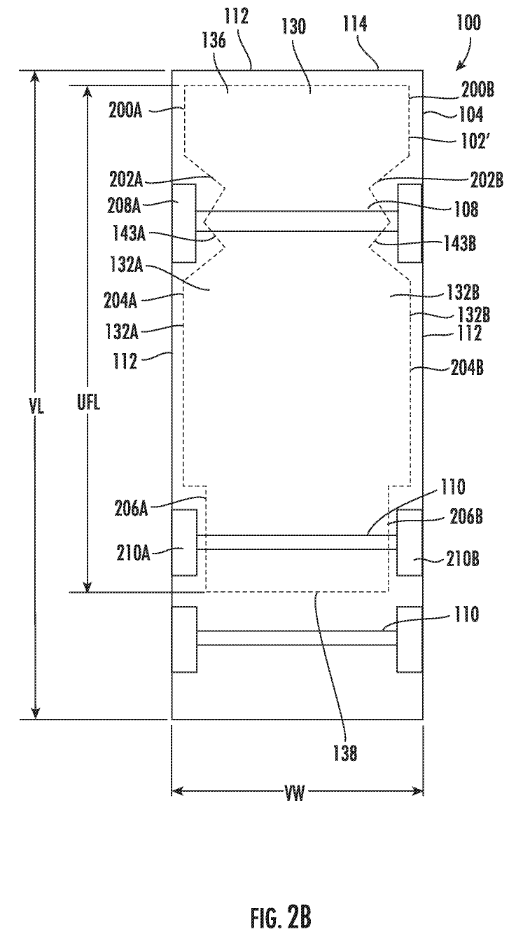

FIGS. 2A-2B are views of another embodiment of the under chassis fairing 102′ with non-planar sidewalls 132A, 132B. The left sidewall 132A includes a frontward laterally extended portion 200A, a frontward laterally recessed portion 202A, a middle laterally extended portion 204A, and a rearward laterally recessed portion 206A. The frontward laterally extended portion 200A is positioned in front of the front left tire 208A. The frontward laterally recessed portion 202A receives the front left tire 208A therein. The middle laterally extended portion 204A is positioned between the front left tire 208A and the back left tire 210A. The rearward laterally recessed portion 206A receives the back left tire 210A therein. The right sidewall 132B includes similar features which are similarly numbered as the left sidewall 132A.

Such a configuration improves aerodynamic performance as the airflow flows past the frontward laterally extended portion 200A, the front left tire 208A, the middle laterally extended portion 204A, and the back left tire 210A. As a result, the under chassis fairing 102′ covers a greater footprint of the vehicle 100 and extends across a greater width of the vehicle 100 than the under chassis fairing 102 of FIGS. 1A-1C.

In certain embodiments, the under chassis fairing 102′ includes couplings that are separate from the guide. In particular, the front coupling is embodied as a U-shaped bracket 124′ and the back coupling is embodied as a strap 126′. More brackets 124′ and/or straps 126′ may be used on the front axle and/or the rear axle.

The under chassis fairing 102′ further includes a pair of frontward columns 148 defining a front vertical slot 153 and a rearward column 150. Such features prevent frontward/rearward lateral movement and side-to-side lateral movement, as similarly discussed above.

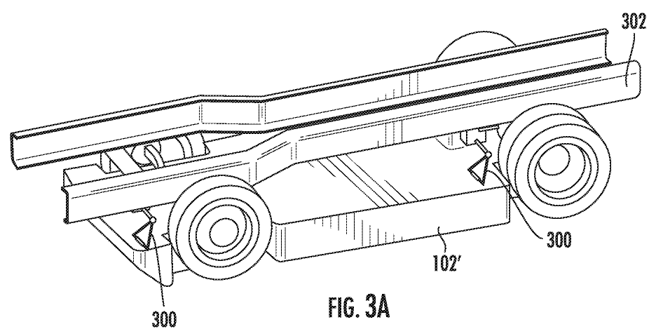

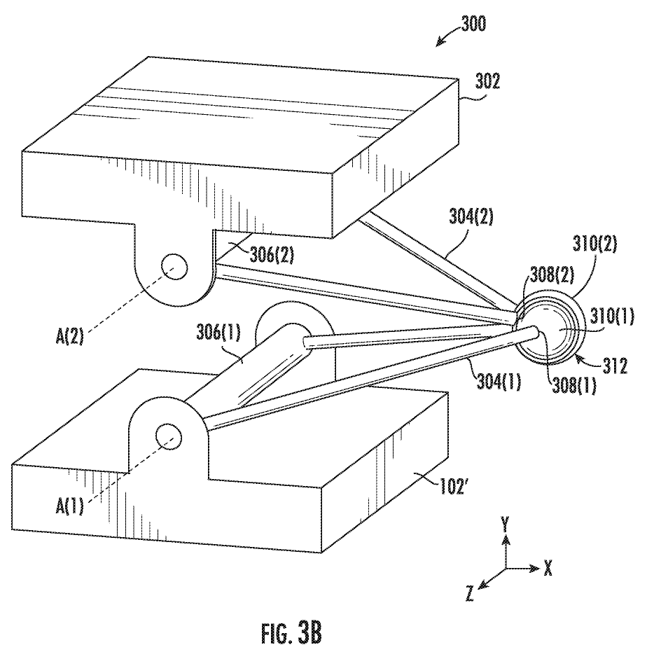

FIGS. 3A-3B are perspective views of the under chassis fairing 102′ of FIGS. 2A-2B mounted by mechanical joints 300 to a chassis 302. In other words, the mechanical joint 300 couples the under chassis fairing 102′ to the chassis 302 (e.g., frame rails). The mechanical joint 300 includes a first triangular linkage 304(1) and a second triangular linkage 304(2).

Referring to FIG. 3B, the first triangular linkage 304(1) includes a base end 306(1) configured to hingedly couple to the under chassis fairing 102′ to pivot relative to the under chassis fairing 302′ about a first axis A(1). In particular, the hinge coupling restricts the first triangular linkage 304(1) to one degree of freedom relative to the under chassis fairing 102′. The first triangular linkage 304(1) further includes a vertex end 308(1) including a first rotational member 310(1).

Similarly, the second triangular linkage 304(2) includes a base end 306(2) configured to hingedly couple to the chassis 302 to pivot relative to the chassis 302 about a second axis A(2). In particular, the hinge coupling restricts the second triangular linkage 304(2) to one degree of freedom relative to chassis 302. The second triangular linkage 304(2) further includes a vertex end 308(2) including a second rotational member 310(2).

The first triangular linkage 304(1) has three rotational degrees of freedom relative to the second triangular linkage 304(2) (about the X axis, Y axis, and Z axis). The first rotational member 310(1) and the second rotational member 310(2) are rotationally coupled to form a ball joint 312 such that the under chassis fairing 102′ is moveable in two translational degrees of freedom (along X axis and Y axis) and restricted in one translational degree of freedom relative to the chassis 302 (along Z axis). The under chassis fairing 102′ may move relative to the chassis 302 in five degrees of freedom (translation along X axis and Y axis and rotation about X axis, Y axis, and Z axis), but the under chassis fairing 102′ is constrained in one translational degree of freedom (along the Z axis).

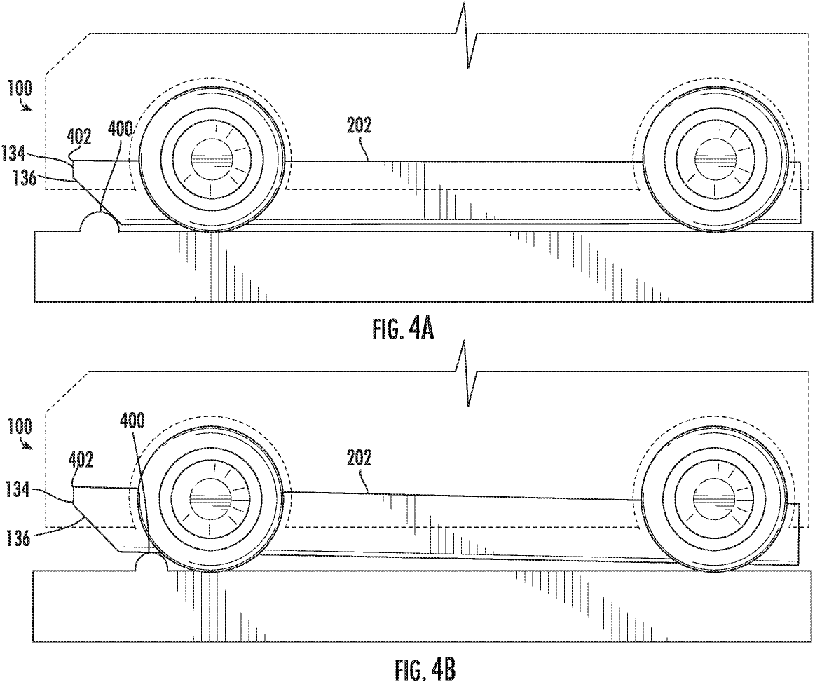

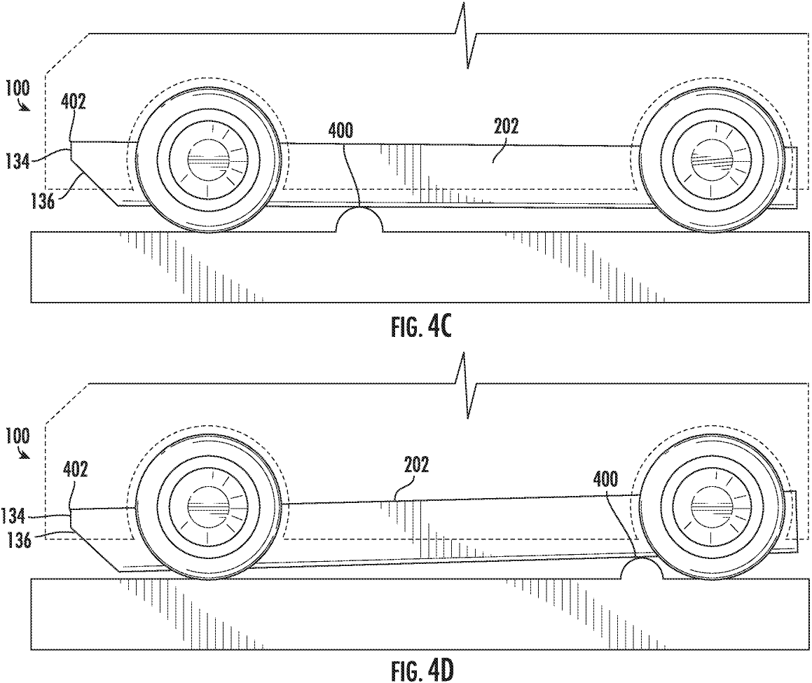

FIG. 4A is a side view of the under chassis fairing 102 of FIGS. 1A-1C illustrating under chassis fairing 202 in an extended position as the under chassis fairing 202 approaches a road obstacle 400. As the under chassis fairing 202 contacts the road obstacle 400, the angled portion 136 of the front wall 130 and the front 402 of the under chassis fairing 202 move upward.

FIG. 4B is a side view of the under chassis fairing 202 of FIG. 4A with a front 402 of the under chassis fairing 202 in a retracted position and a rear 404 of the under chassis fairing 202 in the extended position as the under chassis fairing 202 travels over the road obstacle 400. In particular, the floor 128 of the under chassis fairing 202 contacts the road obstacle 400.

FIG. 4C is a side view of the under chassis fairing 202 of FIG. 4A with the front 402 of the under chassis fairing 202 in the retracted position and the rear 404 of the under chassis fairing 202 in the retracted position as the under chassis fairing 202 travels over the road obstacle 400.

FIG. 4D is a side view of the under chassis fairing 202 of FIG. 4A with the front 402 of the under chassis fairing 202 in the extended position and the rear 404 of the under chassis fairing 202 in the retracted position as the under chassis fairing 202 travels over the road obstacle 400.

Accordingly, the under chassis fairing 202 reduces aerodynamic drag and portions or all of the under chassis fairing 202 can retract upward upon contact with one or more road obstacles 400, thereby preserving ground clearance of the vehicle 100.

Those skilled in the art will recognize improvements and modifications to the preferred embodiments of the present disclosure. All such improvements and modifications are considered within the scope of the concepts disclosed herein and the claims that follow.

What is claimed is:

1. An under chassis fairing, comprising:
a fairing body comprising a floor, a front wall, a left sidewall, and a right sidewall, the front wall extending from a front edge of the fairing body to the floor toward a back edge of the fairing body and being angled relative to the floor; and
at least one coupling configured to hang the fairing body from a chassis of a vehicle such that an upper edge of the left sidewall and the right sidewall is positioned at the same height as or higher than a lower side edge of the outer surface of a vehicle body of the vehicle;
wherein the at least one coupling is configured to allows movement of the fairing body from a lowered position vertically toward the chassis upon contact with a road obstacle.

2. The under chassis fairing of claim 1, wherein the left sidewall and the right sidewall are planar and extend from the front wall to a back edge of the floor.

3. The under chassis fairing of claim 1, wherein each of the left sidewall and the right sidewall comprises a laterally extended portion.

4. The under chassis fairing of claim 1, wherein the fairing body defines a gap between a left rearward edge of the left sidewall and a right rearward edge of the right sidewall.

5. The under chassis fairing of claim 1, wherein the fairing body comprises a metal material.

6. The under chassis fairing of claim 1, wherein the at least one coupling comprises a front coupling configured to hang from a front axle of the chassis of the vehicle.

7. The under chassis fairing of claim 6, wherein the at least one coupling comprises a back coupling configured to hang from a rear axle of the chassis of the vehicle.

8. The under chassis fairing of claim 1, wherein the at least one coupling comprises at least one of a strap, a telescopic strut, a hook, or a bracket.

9. The under chassis fairing of claim 1, wherein the at least one coupling comprises a metal bracket.

10. The under chassis fairing of claim 1, further comprising at least one guide configured to allow vertical movement and restrict lateral movement of the under chassis fairing relative to the chassis.

11. The under chassis fairing of claim 10, wherein the at least one guide comprises at least one vertical slot configured to receive at least a portion of an axle of the chassis therein.

12. The under chassis fairing of claim 10, wherein the at least one coupling comprises the at least one guide.

13. The under chassis fairing of claim 10, wherein the at least one guide comprises a front guide configured to engage at least a portion of a front axle and a back guide configured to engage at least a portion of a rear axle.

14. A vehicle, comprising:
a vehicle body having an outer surface;
a chassis comprising a front axle and a rear axle; and
an under chassis fairing hanging from the chassis, the under chassis fairing comprising:
a fairing body comprising a floor, a front wall, a left sidewall, and a right sidewall, the front wall extending from a front edge of the fairing body to the floor toward a back edge of the fairing body and being angled relative to the floor; and
at least one coupling configured to hang the fairing body from a chassis of a vehicle such that an upper edge of the left sidewall and the right sidewall is positioned at the same height as or higher than a lower side edge of the outer surface of a vehicle body of the vehicle;
wherein the at least one coupling is configured to allow movement of the fairing body from a lowered position vertically relative to the chassis upon contact with a road obstacle.

15. The vehicle of claim 14, wherein the under chassis fairing comprises a front coupling configured to hang from the front axle of the chassis of the vehicle.

16. The vehicle of claim 14, wherein the under chassis fairing further comprises a front guide configured to allow vertical movement and restrict lateral movement of the under chassis fairing relative to the chassis.

17. The vehicle of claim 16, wherein the front axle comprises at least one nub inserted into at least a portion of the front guide to restrict lateral movement of the under chassis fairing relative to the chassis.

18. The vehicle of claim 14, wherein the under chassis fairing comprises a back coupling configured to hang from the rear axle of the chassis of the vehicle.

19. The vehicle of claim 14, wherein the under chassis fairing further comprises a back guide configured to allow vertical movement and restrict lateral movement of the under chassis fairing relative to the chassis.

20. The vehicle of claim 19, wherein the rear axle comprises at least one nub inserted into at least a portion of the back guide to restrict lateral movement of the under chassis fairing relative to the chassis.
